(19) United States
(12) Patent Application Publication
(10) Pub. No.: US 2025/0128732 A1
(43) Pub. Date: Apr. 24, 2025

(54) INFORMATION PROCESSING APPARATUS, INFORMATION PROCESSING METHOD, AND MOVING APPARATUS

(71) Applicant: SONY GROUP CORPORATION, TOKYO (JP)

(72) Inventors: YASUHARU SEKI, TOKYO (JP); YASUYUKI KATO, TOKYO (JP); MASAHIRO TAMORI, TOKYO (JP)

(21) Appl. No.: 18/681,146

(22) PCT Filed: Mar. 8, 2022
(86) PCT No.: PCT/JP2022/009866

§ 371 Date: Feb. 5, 2024

(30) Foreign Application Priority Data
Sep. 1, 2021 (JP) 2021-142330

(51) Int. Cl. B60W 60/00; B60W 40/04; B60W 40/08; B60W 50/14

(52) U.S. Cl. CPC B60W 60/001; B60W 40/04; B60W 40/08; B60W 50/14; B60W 2554/4041; B60W 2554/4042; B60W 2554/4044; B60W 2554/4046; B60W 2554/4049

(57) ABSTRACT

The present technology relates to an information processing apparatus, an information processing method, and a moving apparatus that enable the moving apparatus to move safely in a situation where a moving apparatus that performs automated driving and a moving apparatus that performs manual driving coexist. An information processing apparatus includes a recognition unit that estimates whether or not a second moving apparatus around a first moving apparatus is in automated driving on the basis of sensor data from a sensor provided in the first moving apparatus and used to recognize a situation outside the first moving apparatus. The present technology can be applied to, for example, an information processing apparatus that controls a vehicle.

### TECHNICAL FIELD

The present technology relates to an information processing apparatus, an information processing method, and a moving apparatus and particularly to an information processing apparatus, an information processing method, and a moving apparatus suitable for use in a case where a moving apparatus that performs automated driving and a moving apparatus that performs manual driving coexist.

### BACKGROUND ART

In recent years, automated driving technology has been progressively developed (see, for example, Patent Documents 1 and 2.). In addition, with the spread of automated vehicles in the future, it is assumed that a situation in which automated vehicles and conventional manually driven vehicles coexist will continue for a while.

### CITATION LIST

### Patent Document

Patent Document 1: Japanese Patent Application Laid-Open No. 2018-169706
Patent Document 2: Japanese Patent Application Laid-Open No. 2019-189221

### SUMMARY OF THE INVENTION

### Problems to be Solved by the Invention

Incidentally, it is assumed that driving characteristics are greatly different between the automated vehicle and the manually driven vehicle. For example, it is assumed that the automated vehicle always stably drives in accordance with the traffic rules. On the other hand, the manually driven vehicle does not necessarily always drive in accordance with the traffic rules, such as traveling at a speed exceeding the legal speed according to the surrounding situation. In addition, it is assumed that driving characteristics of the manually driven vehicle change depending on the driver's state or emotion.

Therefore, in a situation where the automated vehicle and the manually driven vehicle coexist, it is assumed that vehicles having greatly different driving characteristics coexist, and measures against this are desired.

The present technology has been made in view of such a situation and aims to enable a moving apparatus to move safely in a situation where a moving apparatus such as a vehicle that performs automated driving and a moving apparatus that performs manual driving coexist.

### Solutions to Problems

An information processing apparatus according to a first aspect of the present technology includes a recognition unit that estimates whether or not a second moving apparatus around a first moving apparatus is in automated driving on the basis of sensor data from a sensor provided in the first moving apparatus and used to recognize a situation outside the first moving apparatus.

In an information processing method according to the first aspect of the present technology, an information processing apparatus provided in a first moving apparatus estimates whether or not a second moving apparatus around the first moving apparatus is in automated driving on the basis of sensor data from a sensor provided in the first moving apparatus and used to recognize a situation outside the first moving apparatus.

In the first aspect of the present technology, whether or not the second moving apparatus around the first moving apparatus is in automated driving is estimated on the basis of sensor data from a sensor provided in the first moving apparatus and used to recognize a situation outside the first moving apparatus.

A moving apparatus according to a second aspect of the present technology includes: a sensor used to recognize an external situation; and a recognition unit that estimates whether or not a surrounding moving apparatus is in automated driving on the basis of sensor data from the sensor.

In the second aspect of the present technology, whether or not a surrounding moving apparatus is in automated driving is estimated on the basis of sensor data from a sensor used to recognize an external situation.

### BRIEF DESCRIPTION OF DRAWINGS

FIG. 1 is a block diagram illustrating a configuration example of a vehicle control system.

FIG. 2 is a diagram illustrating an example of sensing areas.

FIG. 3 is a block diagram illustrating an embodiment of an information processing system to which the present technology is applied.

FIG. 4 is a flowchart for explaining learning data collection processing executed by each vehicle.

FIG. 5 is a flowchart for explaining learning processing executed by a server.

FIG. 6 is a flowchart for explaining driving control processing executed by each vehicle.

FIG. 7 is a flowchart for explaining the driving control processing executed by each vehicle.

FIG. 8 is a block diagram illustrating a configuration example of a computer.

### MODE FOR CARRYING OUT THE INVENTION

Hereinafter, modes for carrying out the present technology will be described. The description will be given in the following order.
1. Configuration Example of Vehicle Control System
2. Embodiments
3. Modifications
4. Others

### 1. Configuration Example of Vehicle Control System

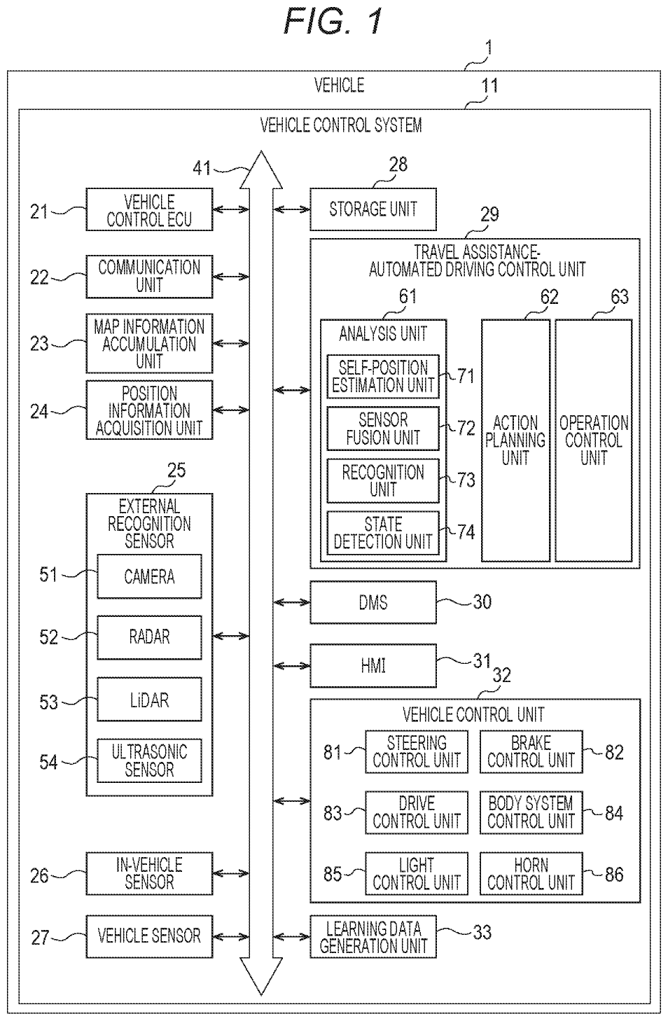

FIG. 1 is a block diagram illustrating a configuration example of a vehicle control system 11 that is an example of a moving apparatus control system to which the present technology is applied.

The vehicle control system 11 is provided in a vehicle 1 and performs processing relating to travel assistance and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a travel assistance-automated driving control unit 29, a driver monitoring system (DMS) 30, a human machine interface (HMI) 31, a vehicle control unit 32, and a learning data generation unit 33.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the travel assistance-automated driving control unit 29, the driver monitoring system (DMS) 30, the human machine interface (HMI) 31, and the vehicle control unit 32 are interconnected such that communication is enabled via a communication network 41. The communication network 41 is constituted by, for example, an in-vehicle communication network, a bus, and the like that conform to a digital bidirectional communication standard such as the controller area network (CAN), local interconnect network (LIN), local area network (LAN), FlexRay (registered trademark), or Ethernet (registered trademark). The communication network 41 may be selectively used depending on the type of data to be transmitted. For example, the CAN may be applied to data related to vehicle control, and the Ethernet may be applied to large-volume data. Note that the units of the vehicle control system 11 are sometimes directly connected to each other not via the communication network 41, for example, using wireless communication intended for a relatively short-range communication, such as near field communication (NFC) or Bluetooth (registered trademark).

Note that, hereinafter, in a case where each unit of the vehicle control system 11 performs communication via the communication network 41, the description of the communication network 41 will be omitted. For example, in a case where the vehicle control ECU 21 and the communication unit 22 perform communication via the communication network 41, it will be simply described that the vehicle control ECU 21 and the communication unit 22 perform communication.

For example, the vehicle control ECU 21 is constituted by various processors such as a central processing unit (CPU) and a micro processing unit (MPU). The vehicle control ECU 21 controls all or some of the functions of the vehicle control system 11.

The communication unit 22 communicates with many kinds of devices inside and outside the vehicle, another vehicle, a server, a base station, and the like and sends and receives various sorts of data. At this time, the communication unit 22 can perform communication using a plurality of communication schemes.

Communication with the outside of the vehicle executable by the communication unit 22 will be concisely described. The communication unit 22 communicates with a server (hereinafter, referred to as an external server) or the like present on an external network via a base station or an access point by, for example, a wireless communication scheme such as fifth generation mobile communication system (5G), long term evolution (LTE), or dedicated short range communications (DSRC). Examples of the external network with which the communication unit 22 performs communication include the Internet, a cloud network, a company-specific network, and the like. The communication scheme by which the communication unit 22 communicates with the external network is not particularly limited as long as it is a wireless communication scheme allowing digital bidirectional communication at a communication speed equal to or higher than a predetermined speed and over a distance equal to or longer than a predetermined distance.

In addition, for example, the communication unit 22 can communicate with a terminal present in the vicinity of the host vehicle, using a peer to peer (P2P) technology. The terminal present in the vicinity of the host vehicle is, for example, a terminal attached to a moving body moving at a relatively low speed, such as a pedestrian or a bicycle, a terminal installed at a fixed position in a store or the like, or a machine type communication (MTC) terminal. Furthermore, the communication unit 22 can also perform vehicle-to-everything (V2X) communication. The V2X communication refers to, for example, communication between the host vehicle and others, such as vehicle to vehicle communication with another vehicle, vehicle to infrastructure communication with a roadside device or the like, vehicle to home communication, and vehicle to pedestrian communication with a terminal or the like carried by a pedestrian.

For example, the communication unit 22 can receive a program for updating software that controls the operation of the vehicle control system 11 from the outside (Over The Air). The communication unit 22 can further receive map information, traffic information, information regarding the surroundings of the vehicle 1, and the like from the outside. In addition, for example, the communication unit 22 can send information regarding the vehicle 1, information on the surroundings of the vehicle 1, and the like to the outside. Examples of the information regarding the vehicle 1 sent to the outside by the communication unit 22 include data indicating the state of the vehicle 1, a recognition result from a recognition unit 73, and the like. Furthermore, for example, the communication unit 22 performs communication supporting a vehicle emergency call system such as eCall.

For example, the communication unit 22 receives an electromagnetic wave sent by the vehicle information and communication system (VICS) (registered trademark) with a radio wave beacon, an optical beacon, frequency modulation (FM) multiplex broadcasting, or the like.

Communication with the inside of the vehicle executable by the communication unit 22 will be concisely described. The communication unit 22 can communicate with each device in the vehicle, using, for example, wireless communication. The communication unit 22 can perform wireless communication with a device in the vehicle by, for example, a communication scheme allowing digital bidirectional communication at a communication speed equal to or higher than a predetermined speed by wireless communication, such as wireless LAN, Bluetooth, NFC, or wireless universal serial bus (WUSB). Besides this, the communication unit 22 can also communicate with each device in the vehicle, using wired communication. For example, the communication unit 22 can communicate with each device in the vehicle by wired communication via a cable connected to a connection terminal (not illustrated). The communication unit 22 can communicate with each device in the vehicle by a communication scheme allowing digital bidirectional communication at a communication speed equal to or higher than a predetermined speed by wired communication, such as universal serial bus (USB), high-definition multimedia interface (HDMI) (registered trademark), or mobile high-definition link (MHL).

Here, the device in the vehicle refers to, for example, a device that is not connected to the communication network 41 in the vehicle. As the device in the vehicle, for example, a mobile device or a wearable device carried by an occupant such as a driver, an information device brought into the vehicle and temporarily installed, or the like is assumed.

The map information accumulation unit 23 accumulates either or both of a map acquired from the outside and a map created by the vehicle 1. For example, the map information accumulation unit 23 accumulates a three-dimensional high-precision map, a global map having a lower precision than the precision of the high-precision map but covering a wider area, and the like.

The high-precision map is, for example, a dynamic map, a point cloud map, a vector map, or the like. The dynamic map is, for example, a map made up of four layers of dynamic information, semi-dynamic information, semi-static information, and static information and is provided to the vehicle 1 from the external server or the like. The point cloud map is a map constituted by point clouds (point cloud data). The vector map is, for example, a map obtained by associating traffic information such as a lane and a position of a traffic light, and the like with a point cloud map and adapting the associated point cloud map to the advanced driver assistance system (ADAS) or autonomous driving (AD).

The point cloud map and the vector map may be provided from, for example, the external server or the like, or may be created by the vehicle 1 and accumulated in the map information accumulation unit 23 as a map for performing matching with a local map to be described later on the basis of a sensing result from a camera 51, a radar 52, a light detection and ranging or laser imaging detection and ranging (LiDAR) 53, or the like. In addition, in a case where the high-precision map is provided from the external server or the like, for example, map data of several hundred meters square regarding a planned route on which the vehicle 1 is to travel from now is acquired from the external server or the like in order to reduce the communication volume.

The position information acquisition unit 24 receives a global navigation satellite system (GNSS) signal from a GNSS satellite and acquires position information on the vehicle 1. The acquired position information is supplied to the travel assistance-automated driving control unit 29. Note that the position information acquisition unit 24 is not limited to a scheme using the GNSS signal and may acquire the position information, for example, using a beacon.

The external recognition sensor 25 includes various sensors used to recognize a situation outside the vehicle 1 and supplies sensor data from each sensor to each unit of the vehicle control system 11. The type and number of sensors included in the external recognition sensor 25 are designated as desired.

For example, the external recognition sensor 25 includes the camera 51, the radar 52, the light detection and ranging or laser imaging detection and ranging (LiDAR) 53, and an ultrasonic sensor 54. Besides this, the external recognition sensor 25 may have a configuration including one or more types of sensors among the camera 51, the radar 52, the LiDAR 53, and the ultrasonic sensor 54. The number of cameras 51, radars 52, LiDARs 53, and ultrasonic sensors 54 is not particularly limited as long as they have a number that practically allows installation in the vehicle 1. In addition, the types of sensors included in the external recognition sensor 25 are not limited to this example, and the external recognition sensor 25 may include a sensor of another type. An example of sensing areas of each sensor included in the external recognition sensor 25 will be described later.

Note that the imaging scheme of the camera 51 is not particularly limited. For example, as the camera 51, cameras of various imaging schemes such as a time of flight (ToF) camera, a stereo camera, a monocular camera, and an infrared camera having imaging schemes capable of distance measurement can be applied, as necessary. Besides this, the camera 51 may be for simply acquiring a captured image without relating to distance measurement.

In addition, for example, the external recognition sensor 25 can include an environmental sensor for detecting the environment for the vehicle 1. The environmental sensor is a sensor for detecting an environment such as weather, climate, and brightness and can include various sensors such as a raindrop sensor, a fog sensor, a sunshine sensor, a snow sensor, and an illuminance sensor, for example.

Furthermore, for example, the external recognition sensor 25 includes a microphone used for detection or the like of a sound around the vehicle 1 or a position of a sound source.

The in-vehicle sensor 26 includes various sensors for detecting information on the inside of the vehicle and supplies sensor data from each sensor to each unit of the vehicle control system 11. The types and number of various sensors included in the in-vehicle sensor 26 are not particularly limited as long as the sensors have a type and number that practically allow installation in the vehicle 1.

For example, the in-vehicle sensor 26 can include one or more types of sensors among a camera, a radar, a seating sensor, a steering wheel sensor, a microphone, and a biometric sensor. As the camera included in the in-vehicle sensor 26, for example, cameras of various imaging schemes capable of distance measurement, such as a ToF camera, a stereo camera, a monocular camera, and an infrared camera, can be used. Besides this, the camera included in the in-vehicle sensor 26 may be for simply acquiring a captured image without relating to distance measurement. The biometric sensor included in the in-vehicle sensor 26 is provided, for example, on a seat, a steering wheel, or the like and detects various sorts of biological information on an occupant such as a driver.

The vehicle sensor 27 includes various sensors for detecting the state of the vehicle 1 and supplies sensor data from each sensor to each unit of the vehicle control system 11. The types and number of various sensors included in the vehicle sensor 27 are not particularly limited as long as the sensors have a type and number that practically allow installation in the vehicle 1.

For example, the vehicle sensor 27 includes a speed sensor, an acceleration sensor, an angular velocity sensor (gyro sensor), and an inertial measurement unit (IMU) obtained by integrating these sensors. For example, the vehicle sensor 27 includes a steering angle sensor that detects a steering angle of a steering wheel, a yaw rate sensor, an accelerator sensor that detects a manipulation amount of an accelerator pedal, and a brake sensor that detects a manipulation amount of a brake pedal. For example, the vehicle sensor 27 includes a rotation sensor that detects the speed of an engine or a motor, an air pressure sensor that detects the air pressure of a tire, a slip rate sensor that detects the slip rate of the tire, and a wheel speed sensor that detects the rotation speed of a wheel. For example, the vehicle sensor 27 includes a battery sensor that detects the state of charge and temperature of a battery, and an impact sensor that detects an external impact.

The storage unit 28 includes at least one of a nonvolatile storage medium or a volatile storage medium and stores data and a program. The storage unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as a storage medium. The storage unit 28 stores various programs and data used by each unit of the vehicle control system 11. For example, the storage unit 28 includes an event data recorder (EDR) and a data storage system for automated driving (DSSAD) and stores information on the vehicle 1 before and after an event such as an accident and information acquired by the in-vehicle sensor 26.

The travel assistance-automated driving control unit 29 controls the travel assistance and automated driving of the vehicle 1. For example, the travel assistance-automated driving control unit 29 includes an analysis unit 61, an action planning unit 62, and an operation control unit 63.

The analysis unit 61 performs analysis processing for the vehicle 1 and a situation around the vehicle 1. The analysis unit 61 includes a self-position estimation unit 71, a sensor fusion unit 72, a recognition unit 73, and a state detection unit 74.

The self-position estimation unit 71 estimates a self-position of the vehicle 1 on the basis of sensor data from the external recognition sensor 25 and the high-precision map accumulated in the map information accumulation unit 23. For example, the self-position estimation unit 71 generates a local map on the basis of sensor data from the external recognition sensor 25 and estimates the self-position of the vehicle 1 by matching the local map with the high-precision map. The position of the vehicle 1 takes, for example, a center of a rear wheel pair axle as a reference.

The local map is, for example, a three-dimensional high-precision map created using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 1 is divided into grids (lattices) of a predetermined size, and an occupancy state of an object is indicated in units of grids. The occupancy state of the object is indicated by, for example, the presence or absence or existence probability of the object. The local map is also used for detection processing and recognition processing for a situation outside the vehicle 1 by the recognition unit 73, for example.

Note that the self-position estimation unit 71 may estimate the self-position of the vehicle 1 on the basis of the position information acquired by position information acquisition unit 24 and sensor data from the vehicle sensor 27.

The sensor fusion unit 72 performs sensor fusion processing to obtain new information by combining a plurality of different types of sensor data (for example, image data supplied from the camera 51 and sensor data supplied from the radar 52). The method for combining different types of sensor data includes integration, fusion, federation, and the like.

The recognition unit 73 executes the detection processing to detect a situation outside the vehicle 1 and the recognition processing to recognize a situation outside the vehicle 1.

For example, the recognition unit 73 performs the detection processing and the recognition processing for a situation outside the vehicle 1 on the basis of information from the external recognition sensor 25, information from the self-position estimation unit 71, information from the sensor fusion unit 72, and the like.

Specifically, for example, the recognition unit 73 performs the detection processing, recognition processing, and the like for an object around the vehicle 1. The object detection processing is, for example, processing of detecting the presence or absence, size, shape, position, motion, and the like of an object. The object recognition processing is, for example, processing of recognizing an attribute such as a type of an object or identifying a specified object. The detection processing and the recognition processing, however, are not necessarily clearly discriminated and sometimes overlap.

For example, the recognition unit 73 detects an object around the vehicle 1 by performing clustering to classify point clouds based on sensor data from the radar 52, the LiDAR 53, or the like into clusters of point clouds. Thus, the presence or absence, size, shape, and position of an object around the vehicle 1 are detected.

For example, the recognition unit 73 detects a motion of an object around the vehicle 1 by performing tracking to follow a motion of the cluster of point clouds classified by clustering. Thus, the speed and the traveling direction (movement vector) of an object around the vehicle 1 are detected.

For example, the recognition unit 73 detects or recognizes a vehicle, a person, a bicycle, an obstacle, a structure, a road, a traffic light, a traffic sign, a road sign, and the like on the basis of the image data supplied from the camera 51. In addition, the recognition unit 73 may recognize the type of an object around the vehicle 1 by performing recognition processing such as semantic segmentation.

For example, the recognition unit 73 can perform recognition processing for traffic rules around the vehicle 1 on the basis of a map accumulated in the map information accumulation unit 23, a result of estimation of the self-position by the self-position estimation unit 71, and a result of recognition of an object around the vehicle 1 by the recognition unit 73. Through this processing, the recognition unit 73 can recognize the position and the state of the traffic light, the content of the traffic sign and the road sign, the content of the traffic regulation, the travelable lane, and the like.

For example, the recognition unit 73 can perform recognition processing for a surrounding environment of the vehicle 1. As the surrounding environment to be recognized by the recognition unit 73, weather, air temperature, humidity, brightness, road surface conditions, and the like are assumed.

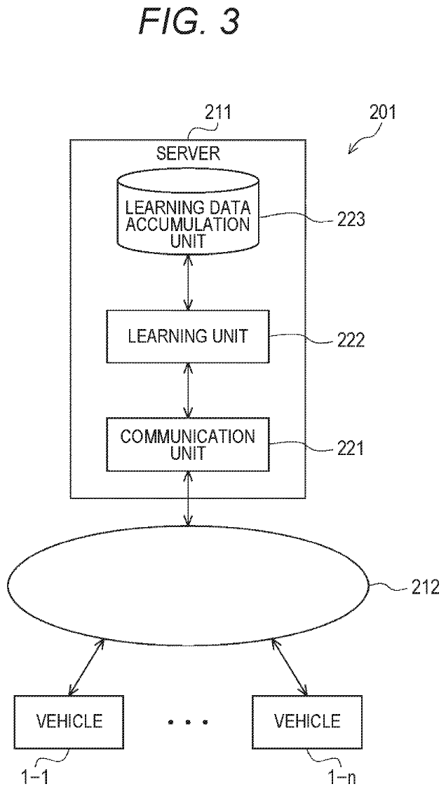

For example, the recognition unit 73 uses a classifier (hereinafter, referred to as an other-vehicle state classifier) trained by a server 211 (FIG. 3) to estimate whether or not another vehicle is in automated driving and the state and emotion of the driver of the another vehicle.

The state detection unit 74 detects the state of the vehicle 1 on the basis of sensor data from the vehicle sensor 27, the self-position of the vehicle 1 estimated by the self-position estimation unit 71, a situation around the vehicle 1 recognized or detected by the recognition unit 73, and the like.

The state of the vehicle 1 to be detected is, for example, a state of the vehicle 1 detectable as seen from another vehicle and includes a traveling state of the vehicle 1. The traveling state of the vehicle 1 includes, for example, a speed, an acceleration, a traveling direction, a timing of braking, a position in a lane, a relative position with respect to surrounding another vehicle, and the like of the vehicle 1.

The action planning unit 62 creates an action plan for the vehicle 1. For example, the action planning unit 62 creates an action plan by performing processing of route planning and route following.

Note that the route planning (global path planning) is processing of planning a rough route from a start to a goal. This route planning also includes processing called a trajectory planning (local path planning) to generate a trajectory in the planned route that allows the vehicle 1 to go safely and smoothly in the vicinity of the vehicle 1 in consideration of the running characteristics of the vehicle 1.

The route following is processing of planning an operation for safely and accurately traveling a route planned by the route planning within a planned time. For example, the action planning unit 62 can calculate a target speed and a target angular velocity of the vehicle 1 on the basis of a result of this route following processing.

The operation control unit 63 controls the operation of the vehicle 1 in order to achieve the action plan created by the action planning unit 62.

For example, the operation control unit 63 controls a steering control unit 81, a brake control unit 82, and a drive control unit 83 included in the vehicle control unit 32 to be described later and performs acceleration and deceleration control and direction control such that the vehicle 1 goes through the trajectory calculated by the trajectory planning. For example, the operation control unit 63 performs coordinated control for the purpose of implementing the functions of the ADAS such as collision avoidance or impact mitigation, follow-up traveling, vehicle-speed maintaining traveling, warning of collision of the host vehicle, warning of lane departure of the host vehicle, and the like. For example, the operation control unit 63 performs coordinated control for the purpose of automated driving or the like in which the vehicle autonomously travels without depending on the manipulation by the driver.

The DMS 30 performs authentication processing for the driver, recognition processing for the state of the driver, and the like on the basis of sensor data from the in-vehicle sensor 26, input data input to the HMI 31 to be described later, and the like. As the state of the driver to be recognized, for example, a physical condition, an alertness level, a concentration level, a fatigue level, a line-of-sight direction, a drunkenness level, a driving manipulation, a posture, and the like are assumed.

Note that the DMS 30 may perform authentication processing for an occupant other than the driver and recognition processing for a state of the occupant. In addition, for example, the DMS 30 may perform recognition processing for a situation inside the vehicle on the basis of sensor data from the in-vehicle sensor 26. As the situation inside the vehicle to be recognized, for example, air temperature, humidity, brightness, odor, and the like are assumed.

The HMI 31 inputs various sorts of data, instructions, and the like and presents various sorts of data to the driver or the like.

The input of data by the HMI 31 will be concisely described. The HMI 31 includes an input device for a person to input data. The HMI 31 generates an input signal on the basis of data, an instruction, or the like input with the input device and supplies the generated input signal to each unit of the vehicle control system 11. The HMI 31 includes, for example, a manipulation element such as a touch panel, a button, a switch, and a lever as the input device. Besides this, the HMI 31 may further include an input device capable of inputting information by a method other than manual manipulation with voice, gesture, or the like. Furthermore, the HMI 31 may use, for example, a remote control apparatus using infrared rays or radio waves, or an external connection device such as a mobile device or a wearable device supporting the manipulation of the vehicle control system 11, as an input device.

Presentation of data by the HMI 31 will be concisely described. The HMI 31 generates visual information, auditory information, and tactile information for an occupant or the outside of the vehicle. In addition, the HMI 31 performs output control to control outputting, output contents, an output timing, an output method, and the like of each piece of generated information. The HMI 31 generates and outputs, as the visual information, information indicated by images or light, such as a manipulation screen, a display of the state of the vehicle 1, a warning display, and a monitor image indicating a situation around the vehicle 1, for example. In addition, the HMI 31 generates and outputs, as the auditory information, information indicated by sounds, such as voice guidance, a warning sound, and a warning message, for example. Furthermore, the HMI 31 generates and outputs, as the tactile information, information given to the tactile sense of an occupant by force, vibration, motion, or the like, for example.

As an output device from which the HMI 31 outputs the visual information, for example, a display apparatus that presents the visual information by displaying an image thereon or a projector apparatus that presents the visual information by projecting an image can be applied. Note that the display apparatus may be an apparatus that displays the visual information in the field of view of an occupant, such as a head-up display, a transmissive display, or a wearable device having an augmented reality (AR) function, as an example, as well as a display apparatus having an ordinary display. In addition, the HMI 31 can also use a display device included in a navigation apparatus, an instrument panel, a camera monitoring system (CMS), an electronic mirror, a lamp, or the like provided in the vehicle 1, as the output device that outputs the visual information.

As the output device from which the HMI 31 outputs the auditory information, for example, an audio speaker, headphones, or an earphone can be applied.

As the output device from which the HMI 31 outputs the tactile information, for example, a haptic element using a haptic technology can be applied. The haptic element is provided, for example, at a portion with which an occupant of the vehicle 1 comes into contact, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including a steering wheel and the like, an electric power steering, and the like. The steering control unit 81 includes, for example, a steering ECU that controls the steering system, an actuator that drives the steering system, and the like.

The brake control unit 82 performs detection, control, and the like of a state of a brake system of the vehicle 1. The brake system includes, for example, a brake mechanism including a brake pedal and the like, an antilock brake system (ABS), a regenerative brake mechanism, and the like. The brake control unit 82 includes, for example, a brake ECU that controls the brake system, an actuator that drives the brake system, and the like.

The drive control unit 83 performs detection, control, and the like of a state of a drive system of the vehicle 1. The drive system includes, for example, an accelerator pedal, a driving force generation apparatus for generating a driving force, such as an internal combustion engine or a driving motor, a driving force transmission mechanism for transmitting the driving force to wheels, and the like. The drive control unit 83 includes, for example, a drive ECU that controls the drive system, an actuator that drives the drive system, and the like.

The body system control unit 84 performs detection, control, and the like of a state of a body system of the vehicle 1. The body system includes, for example, a keyless entry system, a smart key system, a power window apparatus, a power seat, an air conditioner, an airbag, a seat belt, a shift lever, and the like. The body system control unit 84 includes, for example, a body system ECU that controls the body system, an actuator that drives the body system, and the like.

The light control unit 85 performs detection, control, and the like of states of various lights of the vehicle 1. As the lights to be controlled, for example, a headlight, a backlight, a fog light, a turn signal, a brake light, a projection, a bumper display, and the like are assumed. The light control unit 85 includes a light ECU that controls the lights, an actuator that drives the lights, and the like.

The horn control unit 86 performs detection, control, and the like of a state of a car horn of the vehicle 1. The horn control unit 86 includes, for example, a horn ECU that controls the car horn, an actuator that drives the car horn, and the like.

The learning data generation unit 33 generates learning data used for learning of the other-vehicle state classifier described above in the server 211 (FIG. 3) on the basis of a result of detection of a state of the vehicle 1, and a result of detection of a state and a result of estimation of an emotion of the driver of the vehicle 1.

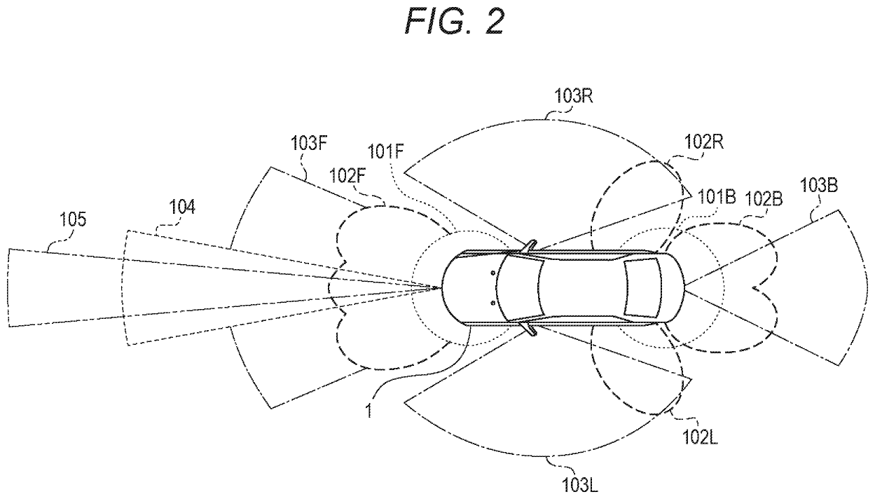

FIG. 2 is a diagram illustrating an example of sensing areas of the camera 51, the radar 52, the LiDAR 53, the ultrasonic sensor 54, and the like of the external recognition sensor 25 in FIG. 1. Note that FIG. 2 schematically illustrates the vehicle 1 as viewed from above, where a left end side is the front end (front) side of the vehicle 1 and a right end side is the rear end (rear) side of the vehicle 1.

Sensing areas 101F and 101B illustrate examples of sensing areas of the ultrasonic sensor 54. The sensing area 101F covers an area near the front end of the vehicle 1 with a plurality of the ultrasonic sensors 54. The sensing area 101B covers an area near the rear end of the vehicle 1 with a plurality of the ultrasonic sensors 54.

Sensing results in the sensing areas 101F and 101B are used for, for example, parking assistance and the like for the vehicle 1.

Sensing areas 102F to 102B illustrate examples of sensing areas of a short-range or medium-range radar 52. The sensing area 102F covers an area extending to a position farther than the sensing area 101F ahead of the vehicle 1. The sensing area 102B covers an area extending to a position farther than the sensing area 101B behind the vehicle 1. The sensing area 102L covers an area near the rear-left side of the vehicle 1. The sensing area 102R covers an area near the rear-right side of the vehicle 1.

A sensing result in the sensing area 102F is used for detection and the like of a vehicle, a pedestrian, or the like present ahead of the vehicle 1, for example. A sensing result in the sensing area 102B is used for a collision prevention function and the like behind the vehicle 1, for example. Sensing results in the sensing areas 102L and 102R are used for detection and the like of an object in a blind spot on the sides of the vehicle 1, for example.

Sensing areas 103F to 103B illustrate examples of sensing areas of the camera 51. The sensing area 103F covers an area extending to a position farther than the sensing area 102F ahead of the vehicle 1. The sensing area 103B covers an area extending to a position farther than the sensing area 102B behind the vehicle 1. The sensing area 103L covers an area near the left side of the vehicle 1. The sensing area 103R covers an area near the right side of the vehicle 1.

A sensing result in the sensing area 103F can be used for, for example, recognition of a traffic light or a traffic sign, a lane departure prevention assist system, and an automatic headlight control system. A sensing result in the sensing area 103B can be used for, for example, parking assistance and a surround view system. Sensing results in the sensing areas 103L and 103R can be used for, for example, a surround view system.

A sensing area 104 illustrates an example of a sensing area of the LiDAR 53. The sensing area 104 covers an area extending to a position farther than the sensing area 103F ahead of the vehicle 1. Meanwhile, the sensing area 104 has a narrower range in a left-right direction than the sensing area 103F.

A sensing result in the sensing area 104 is used for, for example, detection of an object such as a nearby vehicle.

A sensing area 105 illustrates an example of a sensing area of a long-range radar 52. The sensing area 105 covers an area extending to a position farther than the sensing area 104 ahead of the vehicle 1. Meanwhile, the sensing area 105 has a narrower range in the left-right direction than the sensing area 104.

A sensing result in the sensing area 105 is used for adaptive cruise control (ACC), emergency braking, collision avoidance, and the like, for example.

Note that the respective sensing areas of the sensors, namely, the camera 51, the radar 52, the LiDAR 53, and the ultrasonic sensor 54 included in the external recognition sensor 25 may have various configurations other than the configuration in FIG. 2. Specifically, the ultrasonic sensor 54 may also perform sensing on the sides of the vehicle 1, or the LiDAR 53 may perform sensing behind the vehicle 1. In addition, the installation position of each sensor is not limited to each example described above. Furthermore, the number of sensors of each sensor may be one or more.

### 2. Embodiments

Next, an embodiment of the present technology will be described with reference to FIGS. 3 to 7.

### Configuration Example of Information Processing System 201

FIG. 3 illustrates a configuration example of an information processing system 201 to which the present technology is applied.

The information processing system 201 includes vehicles 1-1 to 1-n and the server 211. The vehicles 1-1 to 1-n and the server 211 are connected via a network 212 and can communicate with each other. Note that the vehicles 1-1 to 1-n and the server 211 can also communicate with each other not via the network 212.

Hereinafter, in a case where it is not necessary to individually distinguish the vehicles 1-1 to 1-n, the vehicles 1-1 to 1-n will be simply referred to as vehicles 1.

The server 211 collects learning data from each vehicle 1, performs learning processing for the other-vehicle state classifier, using the collected learning data, and provides the generated other-vehicle state classifier to each vehicle 1. The server 211 includes a communication unit 221, a learning unit 222, and a learning data accumulation unit 223.

The communication unit 221 communicates with each vehicle 1 via the network 212. For example, the communication unit 221 receives learning data from each vehicle 1 and supplies the received learning data to the learning unit 222. For example, the communication unit 221 sends the other-vehicle state classifier supplied from the learning unit 222 to each vehicle 1 via the network 212.

The learning unit 222 accumulates the learning data of each vehicle 1 supplied from the communication unit 221 in the learning data accumulation unit 223. The learning unit 222 performs learning processing for the other-vehicle state classifier, using the learning data accumulated in the learning data accumulation unit 223. The learning unit 222 supplies the generated other-vehicle state classifier to the communication unit 221.

### <Processing of Information Processing System 201>

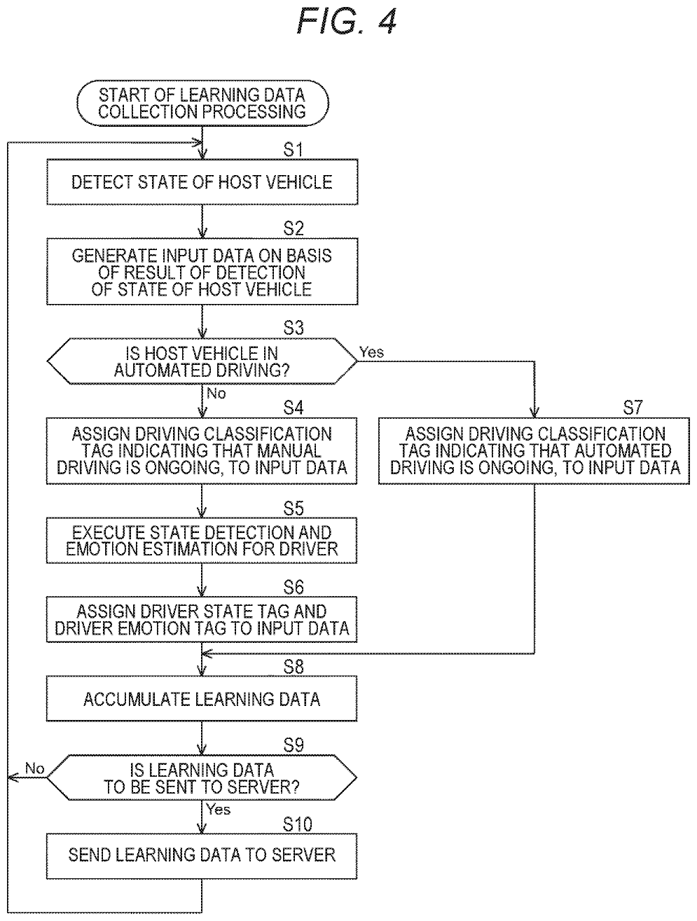

Next, processing of the information processing system 201 will be described with reference to FIGS. 4 to 7.

### <Learning Data Collection Processing>

First, learning data collection processing executed by each vehicle 1 will be described with reference to the flowchart in FIG. 4.

Hereinafter, the vehicle 1 that executes the learning data collection processing will be referred to as a host vehicle. In addition, a vehicle other than the host vehicle will be referred to as another vehicle. Note that another vehicle is not necessarily restricted to the vehicle 1 other than the host vehicle and may be a vehicle other than the vehicle 1.

This processing is started, for example, when the power of the host vehicle is turned on and is ended when the power of the host vehicle is turned off.

In step S1, the state detection unit 74 detects a state of the host vehicle. For example, the state detection unit 74 detects a traveling state of the host vehicle on the basis of sensor data from the vehicle sensor 27, a situation around the vehicle 1 recognized or detected by the recognition unit 73, and the like. For example, the state detection unit 74 detects a speed, an acceleration, a traveling direction, a timing of braking, a position in a lane, a relative position with respect to surrounding another vehicle, and the like of the host vehicle.

The position in the lane of the host vehicle indicates, for example, a relative position of the host vehicle with respect to the left and right dividing lines of the lane in which the host vehicle is traveling.

The state detection unit 74 supplies information indicating a result of detection of the state of the host vehicle to the learning data generation unit 33.

The relative position with respect to another vehicle around the host vehicle indicates, for example, a direction and a distance of the host vehicle with respect to another vehicle around the host vehicle.

In step S2, the learning data generation unit 33 generates input data on the basis of the result of detection of the state of the host vehicle. For example, the learning data generation unit 33 generates input data including a transition of the speed, a transition of the traveling direction (such as wandering as an example), a frequency and timing of braking, a transition of the position in the lane, a transition of the relative position with surrounding another vehicle, and the like of the host vehicle within an immediately preceding predetermined period.

In step S3, the learning data generation unit 33 determines whether or not the host vehicle is in automated driving on the basis of information from the travel assistance-automated driving control unit 29. In a case where it is determined that the host vehicle is not in automated driving, that is, the driver performs manual driving of the host vehicle, the processing proceeds to step S4.

In step S4, the learning data generation unit 33 assigns a driving classification tag indicating that the manual driving is ongoing, to the input data.

In step S5, the DMS 30 executes state detection and emotion estimation for the driver. For example, the DMS 30 acquires image data obtained by capturing the driver, voice data indicating a voice of the driver, and biological information on the driver from the in-vehicle sensor 26. The DMS 30 executes state detection and emotion estimation for the driver on the basis of the acquired image data, voice data, and biological information.

For example, the DMS 30 detects the position and orientation of the face, the orientation of the line of sight, and the motion of an eyelid of the driver on the basis of the acquired image data. The position of the face of the driver is represented by, for example, positions of the face of the driver in a front-rear direction, the left-right direction, and an up-down direction in the vehicle 1. The orientation of the face of the driver is represented by, for example, orientations of the face of the driver in a roll direction, a yaw direction, and a pitch direction.

For example, the DMS 30 detects an improper posture of the driver on the basis of the position and orientation of the face of the driver. For example, an improper posture occurs due to onset of cerebrovascular disease, cardiac or aortic disease, diabetes, epilepsy, or the like, dozing, or the like. For example, the DMS 30 detects an anomalous state of the driver, such as looking-aside, distraction, or dozing on the basis of the orientation of the line of sight of the driver and the motion of an eyelid of the driver.

For example, the DMS 30 detects the facial expression of the driver on the basis of the acquired image data, detects the tone of the voice of the driver on the basis of the acquired voice data, and detects the amount of perspiration, the pulse, and the like of the driver on the basis of the acquired biological information. The DMS 30 estimates an emotion of the driver on the basis of the facial expression, tone of voice, amount of perspiration, pulse, and the like of the driver.

Note that the method of classifying emotions of the driver is not particularly limited. For example, emotions of the driver are classified into joy, security, surprise, anxiety, fear, anger, impatience, irritation, sadness, and the like. For example, emotions of the driver are classified as positive or negative.

In step S6, the learning data generation unit 33 assigns a driver state tag and a driver emotion tag to the input data. That is, the learning data generation unit 33 assigns the driver state tag indicating the detected state of the driver and the driver emotion tag indicating the estimated emotion of the driver, to the input data.

Thereafter, the processing proceeds to step S8.

On the other hand, in a case where it is determined in step S3 that the host vehicle is in automated driving, the processing proceeds to step S7.

In step S7, the learning data generation unit 33 assigns the driving classification tag indicating that the automated driving is ongoing, to the input data.

Thereafter, the processing proceeds to step S8.

In step S8, the learning data generation unit 33 accumulates learning data. That is, the learning data generation unit 33 stores the input data and the learning data including the tags assigned to the input data in the storage unit 28.

In step S9, the learning data generation unit 33 determines whether or not to send the learning data to the server 211. In a case where it is determined not to send the learning data to the server 211, the processing returns to step S1.

Thereafter, processing in steps S1 to S9 is repeatedly executed until it is determined in step S9 that the learning data is to be sent to the server 211. Thus, the learning data is accumulated.

On the other hand, in step S9, for example, in a case where a predetermined condition is satisfied, the learning data generation unit 33 determines to send the learning data, and the processing proceeds to step S10.

Note that the predetermined condition is assumed to be, for example, a case where the accumulation amount of learning data exceeds a predetermined threshold value, a case where a predetermined period has elapsed since the learning data was sent to the server 211 last time, a case where a request is made from the server 211, or the like.

In step S10, the vehicle 1 sends the learning data to the server 211. Specifically, the learning data generation unit 33 reads the learning data from the storage unit 28 and supplies the read learning data to the communication unit 22. The communication unit 22 sends the learning data to the server 211 via the network 212.

In response to this, the communication unit 221 of the server 211 receives the learning data via the network 212 and supplies the learning data to the learning unit 222. The learning unit 222 accumulates the received learning data in the learning data accumulation unit 223.

Thereafter, the processing returns to step S1, and the processing in step S1 and the subsequent steps is executed.

### <Learning Processing>

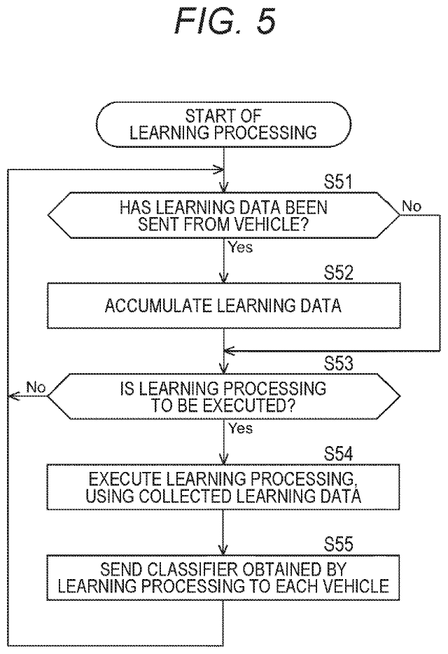

Next, learning processing executed by the server 211 in correspondence with the learning data collection processing executed by each vehicle 1 in FIG. 4 will be described with reference to the flowchart in FIG. 5.

This processing is started, for example, when the power of the server 211 is turned on and is ended when the power of the server 211 is turned off.

In step S51, the communication unit 221 determines whether or not learning data has been sent from the vehicle 1. In a case where the learning data sent from the vehicle 1 in the processing in step S10 in FIG. 4 is received, the communication unit 221 determines that the learning data has been sent from the vehicle 1, and the processing proceeds to step S52.

In step S52, the server 211 accumulates the learning data. Specifically, the communication unit 221 supplies the received learning data to the learning unit 222. The learning unit 222 accumulates the learning data in the learning data accumulation unit 223.

Thereafter, the processing proceeds to step S53.

On the other hand, in a case where it is determined in step S51 that the learning data has not been sent from the vehicle 1, the processing in step S52 is skipped, and the processing proceeds to step S53.

In step S53, the learning unit 222 determines whether or not to execute the learning processing. In a case where it is determined that the learning processing is not to be executed, the processing returns to step S51.

Thereafter, processing in steps S51 to S53 is repeatedly executed until it is determined in step S53 that the learning processing is to be executed. Thus, the learning data is collected from each vehicle 1.

On the other hand, in step S53, in a case where a predetermined condition is satisfied, the learning unit 222 determines to execute the learning processing, and the processing proceeds to step S54.

Note that the predetermined condition is assumed to be, for example, a case where the accumulation amount of the learning data exceeds a predetermined threshold value, a case where a predetermined period has elapsed since the execution of the learning processing, or the like. Thus, the learning processing is periodically executed, and the other-vehicle state classifier is updated.

In step S54, the learning unit 222 executes the learning processing, using the collected learning data. Specifically, the learning unit 222 reads the learning data accumulated in the learning data accumulation unit 223. The learning unit 222 executes the learning processing by a predetermined learning method, using the read learning data, and generates the other-vehicle state classifier.

The other-vehicle state classifier is a classifier that estimates whether or not another vehicle is in automated driving and the state and emotion of the driver of the another vehicle on the basis of the state of the another vehicle.

The state of the another vehicle includes, for example, a traveling state of a type similar to the type of the traveling state of the host vehicle detected in the processing in step S1 in FIG. 4. For example, the speed, the acceleration, the traveling direction, the timing of braking, the position in the lane, the relative position with respect to the surrounding vehicle, and the like of the another vehicle are included.

The state of the driver of the another vehicle includes, for example, a state of the driver of a type similar to the type of the state of the driver of the host vehicle detected in the processing in step S5 in FIG. 4. For example, an improper posture, looking-aside, distraction, dozing, and the like of the driver of the another vehicle are included.

Note that the learning method of the learning unit 222 is not particularly limited. For example, a learning method such as a neural network or a hidden Markov model (HMM) is used.

In step S55, the server 211 sends the classifier obtained by the learning processing to each vehicle 1. Specifically, the learning unit 222 supplies the other-vehicle state classifier obtained by the learning processing to the communication unit 221. The communication unit 221 sends the other-vehicle state classifier to each vehicle 1 via the network 212.

In response to this, each vehicle 1 receives the other-vehicle state classifier via the network 212 and uses the received other-vehicle state classifier for the processing of the recognition unit 73.

Thereafter, the processing returns to step S51, and the processing in step S51 and the subsequent steps is executed.

### <Driving Control Processing>

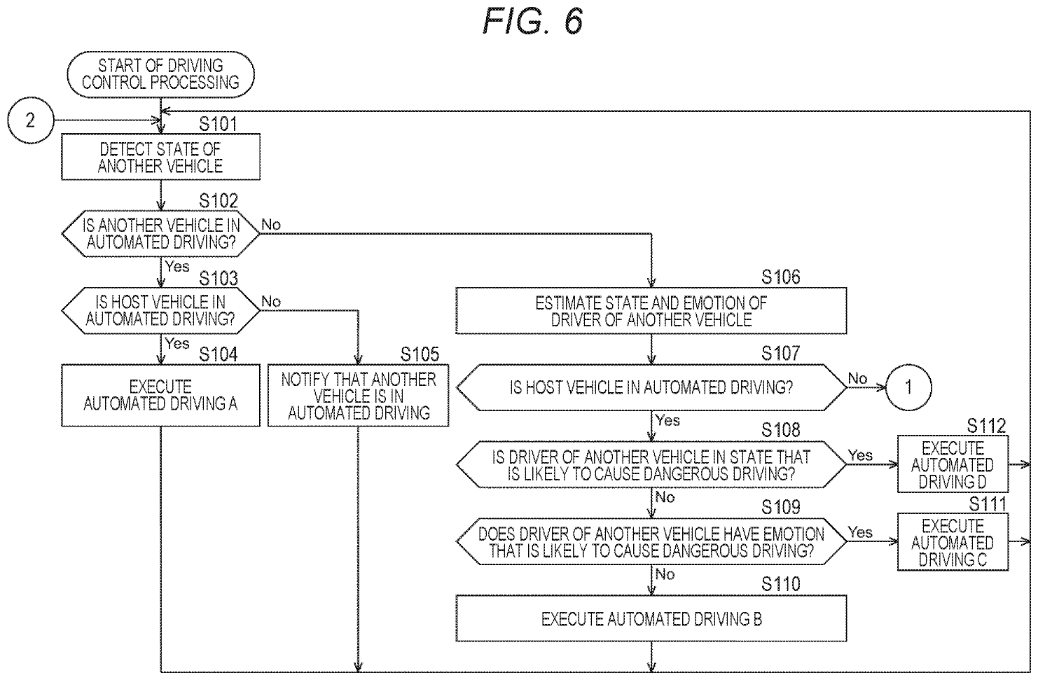

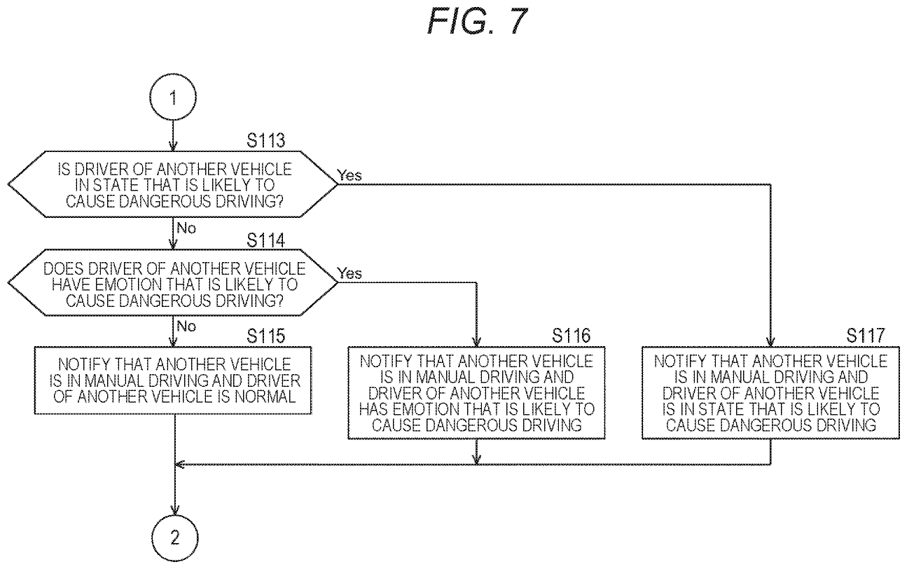

Next, driving control processing executed by each vehicle 1 will be described with reference to the flowcharts in FIGS. 6 and 7.

Hereinafter, the vehicle 1 that executes the driving control processing will be referred to as the host vehicle. In addition, an example of a case where the host vehicle performs driving control according to the states of the vehicle ahead of the host vehicle and the driver will be described below. Therefore, it is supposed, in this processing, that another vehicle refers to a vehicle ahead of the vehicle 1.

This processing is started, for example, when the power of the host vehicle is turned on and is ended when the power of the host vehicle is turned off.

In step S101, the recognition unit 73 detects a state of the another vehicle on the basis of sensor data from each sensor included in the external recognition sensor 25. For example, the recognition unit 73 detects a traveling state of a type similar to the type of the traveling state of the host vehicle detected by the state detection unit 74 in the processing in step S1 in FIG. 4. For example, the recognition unit 73 detects the speed, the acceleration, the traveling direction, the timing of braking, the position in the lane, the relative position with respect to a surrounding vehicle, and the like of the another vehicle.

In step S102, the recognition unit 73 determines whether or not the another vehicle is in automated driving. For example, the recognition unit 73 determines whether or not the another vehicle is in automated driving, using the other-vehicle state classifier on the basis of the transition of the speed, the transition of the traveling direction, the frequency and timing of braking, the transition of the position in the lane, the transition of the relative position with a surrounding vehicle, and the like of the another vehicle within an immediately preceding predetermined period. In a case where it is determined that the another vehicle is in automated driving, the processing proceeds to step S103.

In step S103, it is determined whether or not the host vehicle is in automated driving, similarly to the processing in step S3 in FIG. 4. In a case where it is determined that the host vehicle is in automated driving, the processing proceeds to step S104.

In step S104, the action planning unit 62 and the operation control unit 63 execute automated driving A. That is, the action planning unit 62 creates an action plan corresponding to the automated driving A, and the operation control unit 63 controls the host vehicle in order to implement the action plan corresponding to the automated driving A. Details of the automated driving A will be described later.

Thereafter, the processing returns to step S101, and the processing in step S101 and the subsequent steps is executed.

On the other hand, in a case where it is determined in step S103 that the host vehicle is in manual driving, the processing proceeds to step S105.

In step S105, the HMI 31 notifies that the another vehicle is in automated driving. For example, the HMI 31 outputs visual information or auditory information indicating that the another vehicle is in automated driving.

Thus, the driver of the host vehicle can recognize that the another vehicle is in automated driving and can perform driving corresponding to the recognition.

Thereafter, the processing returns to step S101, and the processing in step S101 and the subsequent steps is executed.

On the other hand, in a case where it is determined in step S102 that the another vehicle is in manual driving, the processing proceeds to step S106.

In step S106, the recognition unit 73 estimates the state and emotion of the driver of the another vehicle. For example, the recognition unit 73 estimates the state and emotion of the driver of the another vehicle on the basis of the transition of the speed, the transition of the traveling direction, the frequency and timing of braking, the transition of the position in the lane, the transition of the relative position with a surrounding vehicle, and the like of the another vehicle within an immediately preceding predetermined period. For example, the recognition unit 73 estimates the presence or absence of an anomalous state such as improper posture, looking-aside, distraction, or dozing of the driver of the another vehicle. For example, the recognition unit 73 estimates emotions such as joy, security, surprise, anxiety, fear, anger, impatience, irritation, and sadness of the driver of the another vehicle.

In step S107, it is determined whether or not the host vehicle is in automated driving, similarly to the processing in step S3 in FIG. 4. In a case where it is determined that the host vehicle is in automated driving, the processing proceeds to step S108.

In step S108, the recognition unit 73 determines whether or not the driver of the another vehicle is in a state that is likely to cause dangerous driving, on the basis of the result of the processing in step S106. In a case where it is determined that the driver of the another vehicle is not in a state that is likely to cause dangerous driving, the processing proceeds to step S109.

In step S109, the recognition unit 73 determines whether or not the driver of the another vehicle has an emotion that is likely to cause dangerous driving, on the basis of the result of the processing in step S106. In a case where it is determined that the driver of the another vehicle does not have an emotion that is likely to cause dangerous driving, the processing proceeds to step S110. This is a case where it is determined that driving by the driver of the another vehicle is safe, on the basis of the result of estimation of the state and emotion of the driver of the another vehicle.

In step S110, the action planning unit 62 and the operation control unit 63 execute automated driving B. That is, the action planning unit 62 creates an action plan corresponding to the automated driving B, and the operation control unit 63 controls the host vehicle in order to implement the action plan corresponding to the automated driving B. Details of the automated driving B will be described later.

Thereafter, the processing returns to step S101, and the processing in step S101 and the subsequent steps is executed.

On the other hand, in a case where it is determined in step S109 that the driver of the another vehicle has an emotion that is likely to cause dangerous driving, the processing proceeds to step S111.

Note that the emotion that is likely to cause dangerous driving is set using, for example, statistics, experiments, machine learning, or the like. For example, emotions as factors that urge the driver to drive fast, such as impatience and irritation, are set as emotions that are likely to cause dangerous driving. For example, negative emotions including impatience and irritation are set as emotions that are likely to cause dangerous driving. For example, even a positive emotion such as joy has a possibility of making the driver lose calmness and distracted if the emotion is too strong. Accordingly, a strong emotion is set as an emotion that is likely to cause dangerous driving, regardless of the type of emotion.

In step S111, the action planning unit 62 and the operation control unit 63 execute automated driving C. That is, the action planning unit 62 creates an action plan corresponding to the automated driving C, and the operation control unit 63 controls the host vehicle in order to implement the action plan corresponding to the automated driving C. Details of the automated driving C will be described later.

Thereafter, the processing returns to step S101, and the processing in step S101 and the subsequent steps is executed.

On the other hand, in a case where it is determined in step S108 that the driver of the another vehicle is in a state that is likely to cause dangerous driving, the processing proceeds to step S112.

Note that, as the state that is likely to cause dangerous driving, for example, an anomalous state such as improper posture, looking-aside, distraction, or dozing is assumed.

In step S112, the action planning unit 62 and the operation control unit 63 execute automated driving D. That is, the action planning unit 62 creates an action plan corresponding to the automated driving D, and the operation control unit 63 controls the host vehicle in order to implement the action plan corresponding to the automated driving D. Details of the automated driving D will be described later.

Thereafter, the processing returns to step S101, and the processing in step S101 and the subsequent steps is executed.

On the other hand, in a case where it is determined in step S107 that the host vehicle is driven manually, the processing proceeds to step S113.

In step S113, similarly to the processing in step S108, it is determined whether or not the driver of the another vehicle is in a state that is likely to cause dangerous driving. In a case where it is determined that the driver of the another vehicle is not in a state that is likely to cause dangerous driving, the processing proceeds to step S114.

In step S114, similarly to the processing in step S109, it is determined whether or not the driver of the another vehicle has an emotion that is likely to cause dangerous driving. In a case where it is determined that the driver of the another vehicle does not have an emotion that is likely to cause dangerous driving, the processing proceeds to step S115.

In step S115, the HMI 31 notifies that the another vehicle is in manual driving and the driver of the another vehicle is normal. For example, the HMI 31 outputs visual information or auditory information indicating that the another vehicle is in manual driving and the driver of the another vehicle is normal.

Thus, the driver of the host vehicle can recognize that the another vehicle is in manual driving and the driver of the another vehicle is normal, and can perform driving corresponding to the recognition.

Thereafter, the processing returns to step S101, and the processing in step S101 and the subsequent steps is executed.

On the other hand, in a case where it is determined in step S114 that the driver of the another vehicle has an emotion that is likely to cause dangerous driving, the processing proceeds to step S116.

In step S116, the HMI 31 notifies that the another vehicle is in manual driving and the driver of the another vehicle has an emotion that is likely to cause dangerous driving. For example, the HMI 31 outputs visual information or auditory information indicating that the another vehicle is in manual driving and the driver of the another vehicle has an emotion that is likely to cause dangerous driving.

Thus, the driver of the host vehicle can recognize that the another vehicle is in manual driving and the driver of the another vehicle has an emotion that is likely to cause dangerous driving, and can perform driving corresponding to the recognition. For example, in order to avoid danger, the driver of the host vehicle can drive the host vehicle so as to increase an inter-vehicle distance with the another vehicle or to go away from the another vehicle.

Thereafter, the processing returns to step S101, and the processing in step S101 and the subsequent steps is executed.

On the other hand, in a case where it is determined in step S113 that the driver of the another vehicle is in a state that is likely to cause dangerous driving, the processing proceeds to step S117.

In step S117, the HMI 31 notifies that the another vehicle is in manual driving and the driver of the another vehicle is in a state that is likely to cause dangerous driving. For example, the HMI 31 outputs visual information or auditory information indicating that the another vehicle is in manual driving and the driver of the another vehicle is in a state that is likely to cause dangerous driving.

Thus, the driver of the host vehicle can recognize that the another vehicle is in manual driving and the driver of the another vehicle is in a state that is likely to cause dangerous driving, and can perform driving corresponding to the recognition. For example, in order to avoid danger, the driver of the host vehicle can drive the host vehicle so as to increase an inter-vehicle distance with the another vehicle or to go away from the another vehicle.

Thereafter, the processing returns to step S101, and the processing in step S101 and the subsequent steps is executed.

Here, details of the automated driving A to D will be described.

The automated driving A is automated driving corresponding to a case where another vehicle is in automated driving.

The automated driving B is automated driving corresponding to a case where another vehicle is in manual driving and the driver of the another vehicle is normal.

The automated driving C is automated driving corresponding to a case where another vehicle is in manual driving and the driver of the another vehicle has an emotion that is likely to cause dangerous driving.

The automated driving D is automated driving corresponding to a case where another vehicle is in manual driving and the driver of the another vehicle is in a state that is likely to cause dangerous driving.

In addition, the degree of danger of driving of the another vehicle is assumed to be in the following order.
1. A case where the driver of another vehicle is in a state that is likely to cause dangerous driving
2. A case where the driver of another vehicle has an emotion that is likely to cause dangerous driving
3. A case where another vehicle is in manual driving and the driver of the another vehicle is normal
4. A case where another vehicle is in automated driving

Grounded on this, for example, an interval (inter-vehicle distance) in the front-rear direction from another vehicle is set as in following formula (1) according to the degree of danger of driving of the another vehicle.

Automated Driving D>Automated Driving C>Automated Driving B>Automated Driving A (1)

That is, the automated driving is executed such that the inter-vehicle distance between the host vehicle and another vehicle becomes longer as the degree of danger of driving of the another vehicle becomes higher. In addition, in a case where another vehicle is in automated driving, the inter-vehicle distance between the host vehicle and the another vehicle is narrowed as compared with a case where the another vehicle is in manual driving. Furthermore, in a case where another vehicle is in manual driving, when it is determined that driving of the another vehicle is not safe, the inter-vehicle distance between the host vehicle and the another vehicle is increased as compared with when it is determined that driving of the another vehicle is safe.

For example, in the automated driving D, it is assumed that the another vehicle performs an unpredictable motion. To cope with this, the host vehicle moves as away as possible from the another vehicle, for example, by a lane shift or the like.

For example, in the automated driving D, it is assumed that another vehicle evacuates to a safe place and stops by a minimal risk maneuver (MRM). To cope with this, the host vehicle predicts the course of the another vehicle and sets the course so as to avoid collision with the another vehicle. For example, in the automated driving A, the host vehicle basically travels in accordance with the traffic rules.

On the other hand, in the automated driving B, the host vehicle travels not in accordance with the traffic rules, as necessary. For example, in a case where there is no particular danger, the host vehicle follows another vehicle at a speed exceeding the legal speed in line with the flow of surrounding vehicles.

In addition, in the automated driving C and D, since another vehicle is highly likely to perform dangerous driving, the host vehicle basically travels in accordance with the traffic rules without being affected by the motion of the another vehicle.

As described above, each vehicle 1 can precisely estimate, on the basis of the state of another vehicle, whether or not the another vehicle is in automated driving and the state and emotion of the driver of the another vehicle.

In addition, each vehicle 1 can estimate whether or not another vehicle is in automated driving and the state and emotion of the driver of the another vehicle on the basis of only the sensor data from the external recognition sensor 25 provided in each one of the vehicles 1. Therefore, in order to execute the above estimation processing, it is not necessary to, for example, prepare an infrastructure or prepare a protocol for exchanging information with another vehicle. As a result, the above estimation processing can be implemented at low cost and quickly.

Furthermore, in a case where each vehicle 1 is in automated driving, each vehicle 1 executes automated driving according to whether or not another vehicle is in automated driving. In addition, in a case where each vehicle 1 is in automated driving, when another vehicle is in manual driving, each vehicle 1 executes automated driving according to the state and emotion of the driver of the another vehicle. Thus, each vehicle 1 can safely perform automated driving while avoiding danger.

In addition, in a case where each vehicle 1 is in manual driving, whether or not another vehicle is in automated driving, and the state and emotion of the driver of the another vehicle are presented to the driver of each vehicle 1. Thus, the driver of each vehicle 1 can safely drive while avoiding danger, according to whether or not another vehicle is in automated driving and the state and emotion of the driver of the another vehicle.

### 3. Modifications

Hereinafter, modifications of the above-described embodiments of the present technology will be described.

While a case where the driving control processing in FIGS. 6 and 7 is executed by focusing on a vehicle ahead of the host vehicle has been described above, this driving control processing can also be executed by focusing on surrounding vehicles other than the vehicle ahead of the host vehicle. For example, in a case of focusing on another vehicle traveling in a lane next to the lane in which the host vehicle is traveling, an interval in the left-right direction between the host vehicle and the another vehicle is set in accordance with formula (1).

For example, the vehicle 1 may control the automated driving by further finely categorizing the types of the automated driving according to the types of the state and emotion of the driver of the another vehicle.

For example, the recognition unit 73 may estimate only one or two of whether or not another vehicle is in automated driving, the state of the driver of the another vehicle, and the emotion of the driver of the another vehicle. In this case, the server 211 generates a classifier that estimates only one or two of whether or not another vehicle is in automated driving, the state of the driver of the another vehicle, and the emotion of the driver of the another vehicle.

For example, a classifier that estimates whether or not another vehicle is in automated driving and a classifier that estimates the state and emotion of the driver of the another vehicle may be separated. In this case, for example, learning data for each classifier is separately created, and each classifier is trained on the basis of its learning data.

The present technology can also be applied to a moving apparatus other than a vehicle. For example, the present technology can also be applied to a moving apparatus such as a flying car. Thus, the moving apparatus can move safely in a situation where a moving apparatus that performs automated driving and a moving apparatus that performs manual driving coexist.

### 4. Others

### Configuration Example of Computer

The above-described series of processing can be executed by hardware and can also be executed by software. In a case where the series of processing is executed by software, a program forming the software is installed in a computer. Here, examples of the computer include a computer incorporated in dedicated hardware, and a general-purpose personal computer capable of executing various functions by installing various programs, for example.

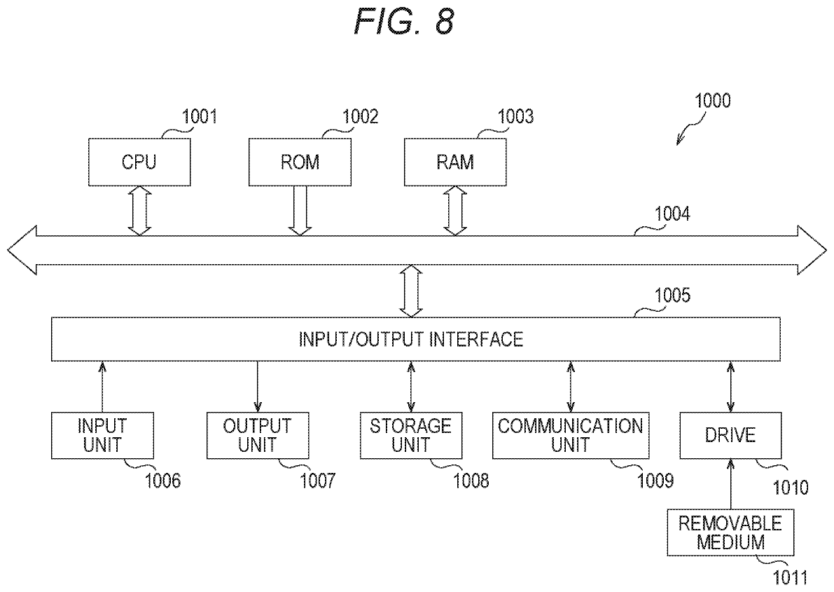

FIG. 8 is a block diagram illustrating a configuration example of hardware of a computer that executes the above-described series of processing with a program.

In a computer 1000, a central processing unit (CPU) 1001, a read only memory (ROM) 1002, and a random access memory (RAM) 1003 are interconnected with a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and the like. The output unit 1007 includes a display, a speaker, and the like. The storage unit 1008 includes a hard disk, a nonvolatile memory, and the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, the series of processing described above is performed, for example, by the CPU 1001 loading a program recorded in the storage unit 1008 into the RAM 1003 via the input/output interface 1005 and the bus 1004 and executing the loaded program.

The program executed by the computer 1000 (CPU 1001) can be provided by being recorded in the removable medium 1011 as a package medium or the like, for example. In addition, the program can be provided via a wired or wireless transmission medium such as a local area network, the Internet, or digital satellite broadcasting.

In the computer 1000, by attaching the removable medium 1011 to the drive 1010, the program can be installed in the storage unit 1008 via the input/output interface 1005. In addition, the program can be received by the communication unit 1009 via a wired or wireless transmission medium and installed in the storage unit 1008. Besides, the program can be installed in the ROM 1002 or the storage unit 1008 in advance.

Note that the program executed by the computer may be a program that performs processing in time series in the order described in the present description, or may be a program that performs processing in parallel or at necessary timings such as when a call is made.

In addition, in the present description, a system is intended to mean assembly of a plurality of components (apparatuses, modules (parts), and the like), and it does not matter whether or not all the components are in the same housing. Therefore, a plurality of apparatuses accommodated in separate housings and connected via a network and one apparatus in which a plurality of modules is accommodated in one housing are both systems.

Furthermore, the embodiments of the present technology are not limited to the above-described embodiments, and a variety of modifications can be made without departing from the gist of the present technology.

For example, the present technology can be configured as cloud computing in which one function is shared and processed together by a plurality of apparatuses via a network.

In addition, each step described in the flowcharts described above can be not only executed by one apparatus, but also executed by a plurality of apparatuses in a shared manner.

Furthermore, in a case where a plurality of processing items is included in one step, the plurality of processing items included in one step can be not only executed by one apparatus, but also executed by a plurality of apparatuses in a shared manner.

### Example of Configuration Combinations

The present technology can also have the following configurations.

(1)

An information processing apparatus including
a recognition unit that estimates whether or not a second moving apparatus around a first moving apparatus is in automated driving on the basis of sensor data from a sensor provided in the first moving apparatus and used to recognize a situation outside the first moving apparatus.
   (2)

The information processing apparatus according to (1) above, in which
the recognition unit detects a state of the second moving apparatus on the basis of the sensor data, and estimates whether or not the second moving apparatus is in automated driving on the basis of the detected state of the second moving apparatus.
   (3)

The information processing apparatus according to (2) above, in which
in a case where the recognition unit estimates that the second moving apparatus is not in automated driving, the recognition unit estimates at least one of a state or an emotion of a driver of the second moving apparatus on the basis of the detected state of the second moving apparatus.
   (4)

The information processing apparatus according to (3) above, further including
an operation control unit that, in a case where the second moving apparatus is not in automated driving, controls automated driving of the first moving apparatus on the basis of an estimation result for at least one of the state or the emotion of the driver of the second moving apparatus.
   (5)

The information processing apparatus according to (4) above, in which
the recognition unit determines whether or not driving of the second moving apparatus is safe on the basis of the estimation result for at least one of the state or the emotion of the driver of the second moving apparatus, and
in a case where it is determined that driving of the second moving apparatus is not safe, the operation control unit increases an interval between the first moving apparatus and the second moving apparatus as compared with a case where it is determined that driving of the second moving apparatus is safe.
   (6)

The information processing apparatus according to (4) or (5) above, in which
the operation control unit controls automated driving of the first moving apparatus further on the basis of the estimation result as to whether or not the second moving apparatus is in automated driving.
   (7)

The information processing apparatus according to any one of (3) to (6) above, further including
a notification control unit that controls notification of the estimation result for at least one of the state or the emotion of the driver of the second moving apparatus, to a driver of the first moving apparatus.
   (8)

The information processing apparatus according to (7) above, in which
the notification control unit further controls notification of the estimation result as to whether or not the second moving apparatus is in automated driving, to the driver of the first moving apparatus.
   (9)

The information processing apparatus according to any one of (3) to (8) above, further including:
a state detection unit that detects a state of the first moving apparatus;
a monitoring unit that executes at least one of state detection or emotion estimation for a driver of the first moving apparatus; and
a learning data generation unit that takes the detected state of the first moving apparatus as input data, and generates learning data in which a tag based on a result of at least one of the state detection or the emotion estimation for the driver of the first moving apparatus is assigned to the input data.
   (10)

The information processing apparatus according to (9) above, in which
the recognition unit estimates at least one of the state or the emotion of the driver of the second moving apparatus, using a classifier trained using the learning data from a plurality of moving apparatuses.
   (11)

The information processing apparatus according to (9) or (10) above, in which
the learning data generation unit generates the learning data in which a tag indicating whether or not the first moving apparatus is in automated driving is further assigned to the input data.
   (12)

The information processing apparatus according to any one of (2) to (11) above, in which
the first moving apparatus and the second moving apparatus include vehicles, and
the state of the second moving apparatus includes at least one of a speed, a traveling direction, a position in a lane, a relative position with a surrounding moving apparatus, a frequency of braking, or a timing of braking.
   (13)

The information processing apparatus according to any one of (1) to (3) above, further including
an operation control unit that controls automated driving of the first moving apparatus on the basis of an estimation result as to whether or not the second moving apparatus is in automated driving.
   (14)

The information processing apparatus according to (13) above, in which
in a case where it is estimated that the second moving apparatus is in automated driving, the operation control unit narrows an interval between the first moving apparatus and the second moving apparatus as compared with a case where it is estimated that the second moving apparatus is in manual driving.
   (15)

The information processing apparatus according to any one of (1) to (6) above, further including
a notification control unit that controls notification of an estimation result as to whether or not the second moving apparatus is in automated driving, to a driver of the first moving apparatus.
   (16)

The information processing apparatus according to any one of (1) to (8) above, further including:
a state detection unit that detects a state of the first moving apparatus; and
a learning data generation unit that takes the detected state of the first moving apparatus as input data, and generates learning data in which a tag indicating whether or not the first moving apparatus is in automated driving is assigned to the input data.
   (17)

The information processing apparatus according to (16) above, in which
the recognition unit estimates whether or not the second moving apparatus is in automated driving, using a classifier trained using the learning data from a plurality of moving apparatuses.
   (18)

An information processing method including,
by an information processing apparatus provided in a first moving apparatus,
estimating whether or not a second moving apparatus around the first moving apparatus is in automated driving on the basis of sensor data from a sensor provided in the first moving apparatus and used to recognize a situation outside the first moving apparatus.
   (19)

A moving apparatus including:
a sensor used to recognize an external situation; and
a recognition unit that estimates whether or not a surrounding moving apparatus is in automated driving on the basis of sensor data from the sensor.

Note that the effects described in the present description are merely examples and are not limited, and other effects may be provided.

### REFERENCE SIGNS LIST

1, 1-1 to 1-n Vehicle
11 Vehicle control system
25 External recognition sensor
26 In-vehicle sensor
27 Vehicle sensor
33 Learning data generation unit
62 Action planning unit
63 Operation control unit
73 Recognition unit
74 State detection unit
201 Information processing system
211 Server
222 Learning unit

1. An information processing apparatus comprising
a recognition unit that estimates whether or not a second moving apparatus around a first moving apparatus is in automated driving on a basis of sensor data from a sensor provided in the first moving apparatus and used to recognize a situation outside the first moving apparatus.

2. The information processing apparatus according to claim 1, wherein
the recognition unit detects a state of the second moving apparatus on a basis of the sensor data, and estimates whether or not the second moving apparatus is in automated driving on a basis of the detected state of the second moving apparatus.

3. The information processing apparatus according to claim 2, wherein
in a case where the recognition unit estimates that the second moving apparatus is not in automated driving, the recognition unit estimates at least one of a state or an emotion of a driver of the second moving apparatus on a basis of the detected state of the second moving apparatus.

4. The information processing apparatus according to claim 3, further comprising
an operation control unit that, in a case where the second moving apparatus is not in automated driving, controls automated driving of the first moving apparatus on a basis of an estimation result for at least one of the state or the emotion of the driver of the second moving apparatus.

5. The information processing apparatus according to claim 4, wherein
the recognition unit determines whether or not driving of the second moving apparatus is safe on a basis of the estimation result for at least one of the state or the emotion of the driver of the second moving apparatus, and
in a case where it is determined that driving of the second moving apparatus is not safe, the operation control unit increases an interval between the first moving apparatus and the second moving apparatus as compared with a case where it is determined that driving of the second moving apparatus is safe.

6. The information processing apparatus according to claim 4, wherein
the operation control unit controls automated driving of the first moving apparatus further on a basis of the estimation result as to whether or not the second moving apparatus is in automated driving.

7. The information processing apparatus according to claim 3, further comprising
a notification control unit that controls notification of the estimation result for at least one of the state or the emotion of the driver of the second moving apparatus, to a driver of the first moving apparatus.

8. The information processing apparatus according to claim 7, wherein
the notification control unit further controls notification of the estimation result as to whether or not the second moving apparatus is in automated driving, to the driver of the first moving apparatus.

9. The information processing apparatus according to claim 3, further comprising:
a state detection unit that detects a state of the first moving apparatus;
a monitoring unit that executes at least one of state detection or emotion estimation for a driver of the first moving apparatus; and
a learning data generation unit that takes the detected state of the first moving apparatus as input data, and generates learning data in which a tag based on a result of at least one of the state detection or the emotion estimation for the driver of the first moving apparatus is assigned to the input data.

10. The information processing apparatus according to claim 9, wherein
the recognition unit estimates at least one of the state or the emotion of the driver of the second moving apparatus, using a classifier trained using the learning data from a plurality of moving apparatuses.

11. The information processing apparatus according to claim 9, wherein
the learning data generation unit generates the learning data in which a tag indicating whether or not the first moving apparatus is in automated driving is further assigned to the input data.

12. The information processing apparatus according to claim 2, wherein
the first moving apparatus and the second moving apparatus include vehicles, and
the state of the second moving apparatus includes at least one of a speed, an acceleration, a traveling direction, a timing of braking, a position in a lane, or a relative position with a surrounding moving apparatus.

13. The information processing apparatus according to claim 1, further comprising
an operation control unit that controls automated driving of the first moving apparatus on a basis of an estimation result as to whether or not the second moving apparatus is in automated driving.

14. The information processing apparatus according to claim 13, wherein
in a case where it is estimated that the second moving apparatus is in automated driving, the operation control unit narrows an interval between the first moving apparatus and the second moving apparatus as compared with a case where it is estimated that the second moving apparatus is in manual driving.

15. The information processing apparatus according to claim 1, further comprising
a notification control unit that controls notification of an estimation result as to whether or not the second moving apparatus is in automated driving, to a driver of the first moving apparatus.

16. The information processing apparatus according to claim 1, further comprising:
a state detection unit that detects a state of the first moving apparatus; and
a learning data generation unit that takes the detected state of the first moving apparatus as input data, and generates learning data in which a tag indicating whether or not the first moving apparatus is in automated driving is assigned to the input data.

17. The information processing apparatus according to claim 16, wherein
the recognition unit estimates whether or not the second moving apparatus is in automated driving, using a classifier trained using the learning data from a plurality of moving apparatuses.

18. An information processing method comprising,
by an information processing apparatus provided in a first moving apparatus,
estimating whether or not a second moving apparatus around the first moving apparatus is in automated driving on a basis of sensor data from a sensor provided in the first moving apparatus and used to recognize a situation outside the first moving apparatus.

19. A moving apparatus comprising:
a sensor used to recognize an external situation; and
a recognition unit that estimates whether or not a surrounding moving apparatus is in automated driving on a basis of sensor data from the sensor.
